(19) United States
(12) Patent Application Publication
(10) Pub. No.: US 2006/0110316 A1
(43) Pub. Date: May 25, 2006

(54) Mesoporous metal oxide

(76) Inventor: Carmine Torardi, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/995,968

(22) Filed: Nov. 23, 2004

(51) Int. Cl. C01G 23/047

(52) U.S. Cl. 423/610; 423/608

(57) ABSTRACT

This invention pertains to mesoporous metal oxides and processes of making mesoporous metal oxides. The metal oxides of the invention can be suitable for use as catalysts, catalyst supports, and nanoparticle precursors. Metal oxides and derivative oxides that may be prepared are the oxides of Ti, Zr, and Hf. Metal oxides prepared via the process described herein may also be suitable for, but not limited to, use in applications involving plastics, coatings, optics, electronics and photovoltaics. The metal oxide products can be agglomerates of crystalline or amorphous material.

### FIELD OF THE INVENTION

This invention pertains to mesoporous metal oxides and processes for making mesoporous metal oxides. More particularly, the metal oxides are oxides of Ti, Zr, and Hf.

### BACKGROUND

The control of particle microstructure is an important commercial activity, useful, for example, in catalysis, electronics, optics, photovoltaics, and energy absorption applications. Control of particle microstructure allows control of physical and electronic properties, and is critical in the development of new functionalized materials. As an example, synthesis of small particle, high surface area inorganic oxides allows good particle dispersion in polymer binder systems for uniform coatings with specific tailored properties, such as light absorption/transmittance, porosity, and durability. It is well known that products having attributes such as small particles, high-surface area, and high porosity can be commercially useful in many applications including, without limitation, as catalysts or catalyst supports.

Titanium dioxide is an important material because of its high refractive index and high scattering power for visible light, making it a good pigment in paints and coatings that require a high level of opaqueness. TiO₂ is also active as a photocatalyst in the decomposition of organic waste materials because it can strongly absorb ultraviolet light and channel the absorbed energy into oxidation-reduction reactions. If the TiO₂ particles are made very small, less than about 100 nm, and if the photoactivity is suppressed by coating the TiO₂ particles, transparent films and coatings can be made that offer UV protection. Therefore, TiO₂ is a versatile material with many existing, as well as potential, commercial applications.

Several processes have been reported that use titanium tetrachloride, TiCl₄, as a starting source of titanium. Often TiCl₄ solutions are neutralized with a base, such as NH₄OH or NaOH, to precipitate a titanium-oxide solid that is washed to remove the salt byproducts, such as NH₄Cl and NaCl. However, for the reaction between TiCl₄ and NH₄OH, the inclusion of the salt byproduct, NH₄Cl, in the precipitated solid in order to control the physical properties of the titania product has not been known.

U.S. Pat. No. 6,444,189 claims an aqueous process for preparing titanium oxide particles using TiCl₄ and ammonum hydroxide followed by filtration and thorough washing of the precipitate to make a powder with an average pore volume of 0.1 cc/g and pore size of 100 Å. Inoue et al. (British Ceramic Transactions 1998 Vol, 97 No. 5 p. 222 ) describes a procedure to make a washed amorphous TiO₂ gel by starting with TiCl₄ and a stoichiometric excess of NH₄OH solution. Publication No. CN 1097400A reacts TiCl₄ with NH₃ gas in alcohol solution to precipitate NH₄Cl salt, but the titanium product is an alkoxide. A hydrated TiO₂ is made by removing the NH₄Cl and hydrolyzing the separated liquid with water.

### SUMMARY OF THE INVENTION

The invention relates to a process for making a mesoporous oxide of titanium, zirconium or hafnium product, comprising:

precipitating an ionic porogen and a hydrolyzed compound comprising titanium, zirconium or hafnium; and removing the ionic porogen from the precipitate to recover a mesoporous oxide of titanium, zirconium or hafnium, the ionic porogen being in sufficient amount to produce (i) a mesoporous titanium oxide product having an average pore volume of at least about 0.5 cc/g and an average pore diameter of at least about 200 Å, (ii) a mesoporous zirconium oxide product having an average pore volume of at least about 0.25 cc/g and an average pore diameter of at least about 100 Å or (iii) a mesoporous hafnium oxide product having an average pore volume of at least about 0.1 cc/g and an average pore diameter of at least about 100 Å.

In another embodiment, the invention relates to a process for producing a mesoporous oxide of titanium, zirconium or hafnium product, the process comprising:

precipitating an ionic porogen and a hydrous oxide of titanium, zirconium or hafnium from a reaction mixture comprising a compound comprising titanium, zirconium or hafnium, a base and a solvent, wherein the compound comprising titanium, zirconium or hafnium or the solvent, or both, are a source of the anion for the ionic porogen and the base is the source of the cation for the ionic porogen; and

removing the ionic porogen from the precipitate to recover (i) a mesoporous titanium oxide product having an average pore volume of at least about 0.5 cc/g and an average pore diameter of at least about 200 Å, (ii) a mesoporous zirconium oxide product having an average pore volume of at least about 0.25 cc/g and an average pore diameter of at least about 100 Å or (iii) a mesoporous hafnium oxide product having an average pore volume of at least about 0.1 cc/g and an average pore diameter of at least about 100 Å.

In yet another embodiment the invention relates to a process for producing a mesoporous oxide of titanium, zirconium or hafnium product, the process comprising:

forming a mixture of a hydrolyzed compound comprising titanium, zirconium or hafnium in a liquid medium;

adding a sufficient quantity of a halide salt to the mixture to saturate the liquid medium of the mixture;

recovering the solid from the saturated liquid medium, the solid comprising a hydrolyzed compound comprising titanium, zirconium or hafnium having pores containing the saturated liquid medium; and

removing the saturated liquid medium from the solid to recover (i) a mesoporous titanium oxide product having an average pore volume of at least about 0.5 cc/g and an average pore diameter of at least about 200 Å, (ii) a mesoporous zirconium oxide product having an average pore volume of at least about 0.25 cc/g and an average pore diameter of at least about 100 Å or (iii) a mesoporous hafnium oxide product having an average pore volume of at least about 0.1 cc/g and an average pore diameter of at least about 100 Å.

In one particular embodiment, the composition of matter of this invention comprises a mesoporous titanium dioxide product having a microstructure characterized by a surface area of at least about 70 m²/g, an average pore volume of least about 0.5 cc/g, and an average pore diameter of least about 200 Å, a composition of matter comprising ZrO₂ having a microstructure characterized by a surface area at least about 70 m²/g, an average pore volume of at least about 0.25 cc/g, and an average pore diameter of at least about 100 Å and a composition of matter comprising HfO₂ having a microstructure characterized by a surface area at least about 40 m²/g, an average pore volume of at least about 0.1 cc/g, and an average pore diameter of at least about 100 Å.

In yet another embodiment, the invention relates to a process for making a mesoporous amorphous oxide of titanium product, comprising:

precipitating an ionic porogen and a hydrolyzed compound comprising titanium; and

removing the ionic porogen from the precipitate to recover a mesoporous oxide of titanium, the ionic porogen being in sufficient amount to produce a mesoporous titanium oxide having a surface area of at least about 400 m²/g and an average pore volume of at least about 0.4 cc/g.

In another particular embodiment the invention relates to a mesoporous amorphous oxide of titanium product having a microstructure characterized by a surface area of at least about 400 m²/g and an average pore volume of at least about 0.4 cc/g.

In yet another embodiment, the invention relates to the use of the metal oxide product of the invention as a catalyst or catalyst support and a nanoparticle precursor. The metal oxide of this invention can be used in plastics, protective coatins, optical devices, electronic devices or photovoltaic cells.

### BRIEF DESCRIPTION OF THE FIGURES

FIG. 1 depicts a scanning electron microscope (SEM) image of calcined powder of Comparative Example A.

FIG. 2 depicts the X-ray powder diffraction pattern of the a product of the process to make TiO₂ using TiCl₄ and NH₄OH in aqueous saturated NH₄Cl as described in Example 1.

FIG. 3 depicts a scanning electron micrograph of the product of the process of Example 3.

FIG. 4 depicts a scanning electron micrograph of the product formed in Example 4.

FIGS. 5 and 6 are scanning electron micrographs of the product formed in Example 5.

### DETAILED DESCRIPTION

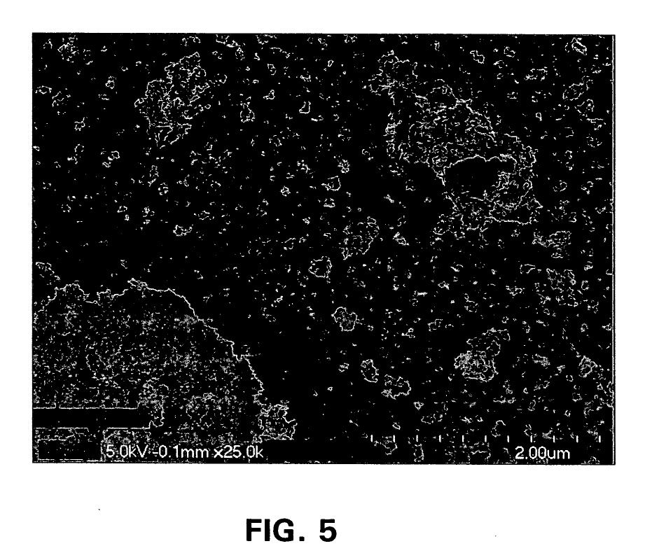

The present invention is directed to a process for forming a highly porous or highly dispersed Group IVB metal oxide, specifically TiO₂, ZrO₂, or HfO₂. The product is typically loosely agglomerated, the term “loosely agglomerated” meaning a microstructure consisting of highly porous clusters of crystals as revealed by scanning electron microscopy at magnifications of about 25,000-100,000×. As best shown in FIG. 5, the microstructure product of this invention can be a rigid sponge-like network of Group IVB metal oxide particles. As described herein, and as shown in the Figures, the porous structures of this invention comprise pores the pores being interstices within an agglomerate of metal oxide particles and/or crystals. The volume of the pores can be measured by porosimetry techniques.

Compositions of matter of this invention can be used as a catalyst, catalyst support, or nanoparticle precursor. Additionally, compositions of matter of this invention can be useful in plastics, optics, electronics, or photovoltaics and, if passivated, for UV light degradation resistance in sunscreens and other protective coatings including paints and stains.

The process of this invention uses a porogen. A porogen is a substance that will create porous structures by functioning as a template for the microstructure of the Group IVB metal oxide. The porogen can be removed from the microstructure to recover a mesoporous Group IVB metal oxide. Preferably the porogen is ionic.

When the porogen is ionic, it can be formed in situ from the Group IVB metal compound or the solvent, or both and a base. The metal compound or the solvent can function as the source of the anion for the ionic porogen. The base can function as the source of the cation for the ionic porogen.

Alternatively, an ionic porogen can be added during the process, for example by addition of ammonium chloride to the mixture of hydrolyzed compound comprising Ti, Zr or Hf and liquid medium.

Methods for removing the porogen can include washing, calcining, firing, subliming, decomposing and melting. It has been found that the choice of technique for removing the porogen depends upon whether a substantially or completely crystalline material is desired or whether an amorphous material is desired. When an amorphous material is desired the porogen can be removed by washing. When a crystalline material is desired the porogen can be removed by volatilizing, such as calcining.

A Group IVB metal compound as a starting material for the metal of the metal oxide is used. The Group IVB metal compound can be a halide of a Group IVB metal or an oxyhalide of a Group IVB metal. Specific examples of useful Group IVB metal compounds include titanium tetrachloride, titanium oxychloride, zirconium oxychloride and hafnium oxychloride. It is believed that metal compounds containing organic groups will work in the process of this invention, however, a titanium alkoxide was found to form mesoporous metal oxides having an average pore volume and an average pore diameter lower than preferred.

A hydrous metal oxide intermediate forms from the starting material for the metal oxide in the presence of base or aqueous solvent, depending upon the reaction mechanism.

A base can be used to precipitate the hydrous metal oxide intermediate. A base can also serve as the source of cations for the porogen. Suitable bases for the practice of the invention include NH₄OH, (NH₄)₂CO₃, NH₄HCO₃, (CH₃)₄NOH, (CH₃CH₂)₄NOH, or other base or mixture of bases that can be later removed by washing or calcining. NH₄OH is preferred.

In one embodiment of the invention, a solvent can be used. A suitable solvent will depend upon the reaction mechanism, as discussed below. Solvents can be aqueous or organic, depending upon the Group IVB metal starting material. Suitable aqueous solvents include water (when additional salt is added as discussed below) or saturated aqueous ammonium chloride. Suitable organic solvents include lower alkyl group alcohols and dimethylacetamide. Examples of lower alkyl group alcohols include ethanol, isopropanol and n-propanol.

Many organic solvents, such as alcohols, aldehydes, ketones, and amines, have a low capacity for dissolved ammonium chloride but the choice of solvent will depend upon the reaction mechanism and the porosity desired. For a totally aqueous solvent system, a very low or zero level of ammonium-chloride solubility exists in saturated aqueous ammonium-chloride solution. When organic solvents, such as those mentioned above, are combined with aqueous reagents, such as 50 wt % TiCl₄ in water and concentrated NH₄OH, the resulting organic-water liquid portion of the reaction mixture will dissolve more of the ammonium-chloride byproduct than would be dissolved in the organic solvent alone. However, under the conditions of this invention, enough undissolved ammonium-chloride precipitate can remain to ultimately produce a high-porosity metal-oxide product. The solubility of the ammonium chloride in the organic-water or saturated aqueous ammonium chloride solvents, and its influence on the porosity of the metal-oxide can be affected by the form of the TiCl₄ introduced into the reaction. For example, TiCl₄ can be introduced as neat and anhydrous, or as aqueous solutions. For the anhydrous TiCl₄, as the H₂O/TiCl₄ weight ratio increases, the ammonium chloride solubility will increase, and the porosity of the product will decrease. Similar results would be obtained for aqueous solutions of base as the H₂O/base ratio increases. In addition to low ammonium-chloride solubility, other solvent-specific factors, such as the different rates of ammonium chloride and metal-oxide precipitation and crystallization, can affect the nature of the composite precipitate and the ability of the precipitated ammonium chloride to produce the high-porosity metal-oxide product.

In a preferred embodiment, the Group IVB metal starting material is a Group IVB metal chloride or oxychloride. Without wishing to be limited thereto, the process of the invention will be described hereinbelow with respect to a metal chloride and/or a metal oxychloride.

In the process of the invention, a solvent, such as an alcohol, preferably n-propanol or iso-propanol, or an alcohol containing dissolved ammonium chloride or organic chloride salt, or water containing dissolved ammonium chloride or organic chloride salt, preferably saturated, is combined with the metal chloride, such as titanium tetrachloride, or metal oxychloride, such as titanium oxychloride, ZrOCl₂.8H₂O or HfOCl₂.8H₂O, to form a solution having a metal concentration in the range of about 5.0-0.01 M, preferably 0.5-0.05 M. A solvent such as ethanol, or dimethylacetamide (DMAc) may be used with or without dissolved ammonium chloride or organic chloride salt. The metal chloride or oxychloride may be combined with the solvent as the neat liquid or solid, or as an aqueous or organic solution. For example, in the synthesis of TiO₂, the titanium chloride may be combined with the solvent as the neat liquid, or as a clear concentrated aqueous solution such as 1:1 TiCl₄:H₂O, i.e., 50% wt. TiCl₄ also referred to as titanium oxychloride solution. To the solvent-metal-chloride solution so formed is added a base to precipitate the titanium. Suitable bases for the practice of the invention include NH₄OH, NH₄HCO₃, (NH₄)₂CO₃, (CH₃)₄NOH, (CH₃CH₂)₄NOH, or other base or mixture of bases that can be removed by washing or calcining. NH₄OH is preferred.

In another embodiment of the invention, a solvent, such as an alcohol, preferably n-propanol or iso-propanol, or an alcohol containing dissolved ammonium chloride or organic chloride salt, or water containing dissolved ammonium chloride or organic chloride salt, preferably saturated, is first combined with the base, preferably NH₄OH, followed by the addition of the metal chloride or metal oxychloride. The metal chloride or oxychloride may be added to the solvent-base solution as the neat liquid or solid, or, preferably, as an aqueous or organic solution.

The process can use a solvent in which the metal chloride is soluble and in which the majority of chloride byproduct, formed upon addition of the base, is insoluble. The mixed chloride salt, e.g., ammonium chloride, serves as the porogen. If the chloride salt is removed by washing with water, an amorphous or poorly crystalline, very high surface area, high porosity network of metal oxide remains. If the chloride salt is removed by calcining, a nanocrystalline, high surface area, high porosity, mesoporous network is formed composed of metal oxide nanocrystals.

It has been found that titania powder having a high porosity can be obtained by using a high level of precipitated ammonium-chloride, which acts as the porogen. This can be accomplished by performing the acid-base reaction in a solvent system having limited ammonium-chloride solubility thereby precipitating more than about 50 wt % of the ammonium chloride by-product, with precipitation of more than about 70 wt % by-product preferred, and precipitation of greater than about 90 wt % by-product most preferred.

Instead of forming an ionic porogen in situ, an ionic porogen can be added during a step of the process. In this embodiment of the invention, for example, a sufficient quantity of a halide salt can be added, after the hydrous metal oxide is precipitated, to saturate the liquid medium, and a solid recovered from the saturated liquid medium comprises a hydrolyzed metal compound having pores containing the saturated liquid medium and the saturated liquid medium is removed from the solid to recover the mesoporous Group IVB metal oxide. Typically the liquid medium is the liquid portion of the mixture of solvent, with or without dissolved salt, and hydrous metal oxide. As an example, a titanium chloride or titanium oxychloride is combined with water to form a solution having a metal concentration in the range of about 5.0-0.01 M, preferably 0.5-0.05 M. The metal chloride or oxychloride can be combined with water as the neat liquid or solid, or as an aqueous or organic solution. To the water-metal-chloride solution so formed is added a base to precipitate the hydrous metal oxide. Suitable bases for the practice of the invention include NH₄OH, NH₄HCO₃, (NH₄)₂CO₃, (CH₃)₄NOH, (CH₃CH₂)₄NOH, or other base or mixture of bases that can be later removed by washing or calcining. NH₄OH is preferred. To the mixture containing the precipitated hydrous metal-oxide is added ammonium chloride or organic chloride salt to saturate the aqueous part of the mixture thereafter the mesoporous product is recovered. The mesoporous product is recovered by removing the saturated liquid medium. Typically, this is accomplished by drying to volatilize the liquid and calcining to remove the porogen which remains after drying.

In general, after blending together the starting materials, as described above, the resulting mixture is mixed, preferably at room temperature, for at least 1 minute but may continue for several hours. Normally, mixing for 5-60 minutes will suffice. A mixed metal-oxide/halide-salt precipitate can be recovered by any convenient method including settling, followed by decanting the supernatant liquid, filtration, centrifugation and so forth.

In a specific embodiment of the invention, it has been found that using solvents with low NH₄Cl solubility can yield TiO₂ powder having a high surface area, an average pore volume of about 0.3 to about 1.0 cc/g, and average pore diameter greater than about 300 Å.

If a very high surface area metal oxide is desired, the recovered solid, however collected, can be slurried with fresh water to remove the porogen, optionally, followed by additional washing steps. The metal oxide recovered by washing the solid to remove the porogen is substantially or completely amorphous and has a very high surface area, typically at least about 400 m²/g, typically in the range of about 400 to about 600 m²/g. The average pore volume of the amorphous metal oxide can be at least about 0.4 cc/g, typically in the range of about 0.4 to about 1.0. The number of washing steps required to achieve the desired level of metal oxide purity will depend upon the solubility of the porogen, the amount of water employed, and the efficiency of the mixing process. The recovered solid can be dried by any convenient means including but not limited to radiative warming and oven heating. The metal oxide product thereby obtained usually contains some volatile matter, mainly water that can be remove by calcination. As an example, a very high surface area, high porosity titania having a surface area of at least 400 m²/g and average pore volume of at least about 0.4 cc/g may be synthesized using the process of this invention. As reported herein, the pore volumes and pore diameters were determined by nitrogen porosimetry, and the surface areas were determined by BET.

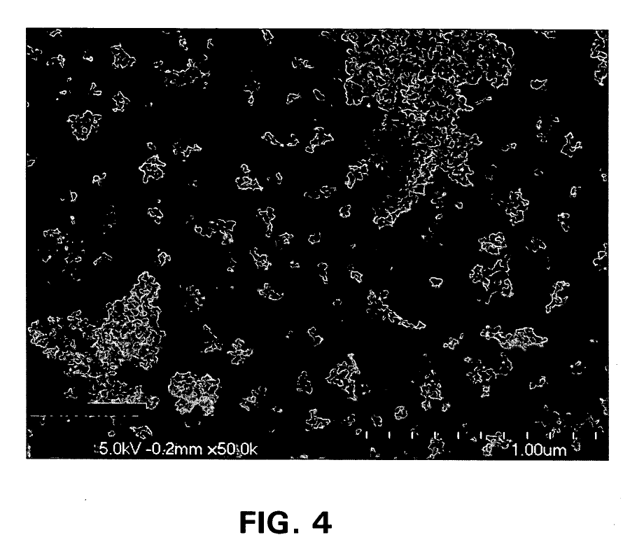

Alternatively, if a high surface area, high porosity, mesoporous, nanocrystalline, loosely-agglomerated metal oxide is desired, the recovered metal-oxide/chloride-salt precipitate, however collected, can be calcined at a temperature that removes the chloride salt from the metal oxide by sublimation, boiling, or decomposition. In the case of preparing TiO₂ from TiCl₄ and NH₄OH in saturated aqueous ammonium chloride, the 450° C.-calcined product is composed of loosely agglomerated nanocrystals of anatase, although some rutile, brookite, or X-ray amorphous material may also be present. The size of the anatase nanocrystals is a function of the calcination temperature and calcination time. At a calcination temperature of 450° C., the average crystallite size can be from about 10-15 nm. By loosely agglomerated is meant having a microstructure consisting of highly porous clusters of anatase crystals as revealed by scanning electron microscopy at magnifications of about 25,000-100,000×. FIG. 4 depicts a scanning electron micrograph of the specimen of Example 4 herein at magnification of 50,000×.

The calcined TiO₂ made by the process of the invention is characterized by a combination of high surface area, high average pore volume, and large average pore diameter. By high surface is meant at least about 70 m²/g, high average pore volume at least about 0.5 cc/g, preferably at least about 0.6 cc/g, and large average pore diameter at least about 200 Å, preferably at least about 300 Å.

The crystalline titanium oxide product made by the process of this invention can comprise loosely agglomerated nanocrystals predominantly, if not completely, having an anatase crystal structure. When the product is not completely anatase, a minor amount of rutile, brookite, and/or X-ray amorphous material may be present.

Calcined ZrO₂ made by the process of the invention is also characterized by a combination of high surface area, high average pore volume, and large average pore diameter that is not attainable outside the process of the invention. For ZrO₂, the high surface is at least about 70 m²/g, high average pore volume at least about 0.25 cc/g, and large average pore diameter of at least about 100 Å, preferably at least about 150 Å.

Calcined HfO₂ made by the process of the invention is also characterized by a combination of high average pore volume and large average pore diameter that is not attainable outside the process of the invention. For HfO₂, the high surface area is at least about 40 m²/g, high average pore volume at least about 0.1 cc/g, and large average pore diameter at least about 100 Å, preferably at least about 120 Å.

The process of the invention may be performed in both batch and continuous modes. The solvent can be separated from the recovered metal-oxide/chloride-salt solid and recycled. The volatile chloride salt, or volatile chloride salt decomposition products, can be condensed, then recycled or disposed.

In one embodiment of the invention the oxide of titanium, zirconium or hafnium further comprises a dopant which can be a transition metal, a Group IIA, IIIA, IVA, or VA metal. Specifically, without limitation thereto, the dopant can be Ge, P, As, Sb, Bi, Ni, Cu, Al, Zr, Hf, Si, Nb, Ta, Fe, Sn, Co, Zn, Mo, W, V, Cr, Mn, Mg, Ca, Sr, Ba, Ga, or In. Methods for incorporating dopants into the oxide would be apparent to this skilled in the art. For example, a dopant-containing compound could be added with the titanium, zirconium or hafnium-containing starting material.

Compositions of matter of this invention can be used as a catalyst or catalyst support. For example, the catalytic properties of TiO₂ are well known to those skilled in the catalyst art. Use of the compositions of matter of this invention as catalysts or catalyst supports would be apparent to those skilled in the catalyst art.

Compositions of matter of this invention can be used as nanoparticle precursors. The Group IVB metal oxide agglomerates formed by the process of this invention can be formed into nanoparticles by any suitable deagglomeration technique. As an example, product of this invention can be deagglomerated by combining the product with water and a suitable sufactant such as, without being limited thereto, tetrasodiumpyrophosphate followed by sonication to break-up the agglomerates. However, other suitable techniques for breaking-up the agglomerates would be apparent to those skilled in the metal oxide powder art. Typically, deagglomeration is by sonication or media milling.

The deagglomerated titanium dioxide product of this invention, if photo passivated, can be especially useful for UV light degradation resistance in plastics, sunscreens and other protective coatings including paints and stains.

The titanium dioxide product of this invention can be photo passivated by treatment with silica and/or alumina by any of several methods which are well known in the art including, without limit, silica and/or alumina wet treatments used for treating pigment-sized titanium dioxide.

The titanium dioxide product of this invention can also have an organic coating which may be applied using techniques known by those skilled in the art. A wide variety of organic coatings are known. Organic coatings employed for pigment-sized titanium dioxide may be utilized. Examples of organic coatings that are well known to those skilled in the art include fatty acids, such as stearic acid; fatty acid esters; fatty alcohols, such as stearyl alcohol; polyols such as trimethylpropane diol or trimethyl pentane diol; acrylic monomers, oligomers and polymers; and silicones, such as polydimethylsiloxane and reactive silicones such as methylhydroxysiloxane.

Organic coating agents can include but are not limited to carboxylic acids such as adipic acid, terephthalic acid, lauric acid, myristic acid, palmitic acid, stearic acid, oleic acid, salicylic acid, malic acid, maleic acid, and esters, fatty acid esters, fatty alcohols, such as stearyl alcohol, or salts thereof, polyols such as trimethylpropane diol or trimethyl pentane diol; acrylic monomers, oligomers and polymers. In addition, silicon-containing compounds are also of utility. Examples of silicon compounds include but are not limited to a silicate or organic silane or siloxane including silicate, organoalkoxysilane, aminosilane, epoxysilane, and mercaptosilane such as hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, octadecyltriethoxysilane, N-(2-aminoethyl) 3-aminopropylmethyl dimethoxysilane, N-(2-aminoethyl) 3-aminopropyl trimethoxysilane, 3-aminopropyl triethoxysilane, 3-glycidoxypropyl trimethoxysilane, 3-glycidoxypropyl methyldimethoxysilane, 3-mercaptopropyl trimethoxysilane and combinations of two or more thereof. Polydimethylsiloxane and reactive silicones such as methylhydroxysiloxane may also be useful.

The titanium dioxide product of this invention may also be coated with a silane having the formula:
RₓSi(R′)₄₋ₓ
wherein
R is a nonhydrolyzable aliphatic, cycloaliphatic or aromatic group having at least 1 to about 20 carbon atoms;
R′ is a hydrolyzable group such as an alkoxy, halogen, acetoxy or hydroxy or mixtures thereof; and
x=1 to3.

For example, silanes useful in carrying out the invention include hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane and octadecyltriethoxysilane. Additional examples of silanes include, R=8-18 carbon atoms; R′=chloro, methoxy, hydroxy or mixtures thereof; and x=1 to 3. Preferred silanes are R=8-18 carbon atoms; R′=ethoxy; and x=1 to 3. Mixtures of silanes are contemplated equivalents. The weight content of the treating agent, based on total treated particles can range from about 0.1 to about 10 wt. %, additionally about 0.7 to about 7.0 wt. % and additionally from about 0.5 to about 5 wt %.

The titanium dioxide particles of this invention can be silanized as described in U.S. Pat. Nos. 5,889,090; 5,607,994; 5,631,310; and 5,959,004 which are each incorporated by reference herein in their entireties.

The titanium dioxide product of this invention may be treated to have any one or more of the foregoing organic coatings.

Titanium dioxide product made according to the present invention may be used with advantage in various applications including without limitation, coating formulations such as sunscreens, cosmetics, automotive coatings, wood coatings, and other surface coatings; chemical mechanical planarization products; catalyst products; photovoltaic cells; plastic parts, films, and resin systems including agricultural films, food packaging films, molded automotive plastic parts, and engineering polymer resins; rubber based products including silicone rubbers; textile fibers, woven and nonwoven applications including polyamide, polyaramid, and polyimides fibers products and nonwoven sheets products; ceramics; glass products including architectural glass, automotive safety glass, and industrial glass; electronic components; and other uses in which photo and chemically passivated titanium dioxide will be useful.

Thus in one embodiment, the invention is directed to a coating composition suitable for protection against ultraviolet light comprising an additive amount suitable for imparting protection against ultraviolet light of photo passivated titanium dioxide nanoparticles made in accordance with this invention dispersed in a protective coating formulation.

One area of increasing demand for titanium dioxide nanoparticles is in cosmetic formulations, particularly in sunscreens as a sunscreen agent. Titanium dioxide nanoparticles provide protection from the harmful ultraviolet rays of the sun (UV A and UV B radiation).

A dispersant is usually required to effectively disperse titanium dioxide nanoparticles in a fluid medium. Careful selection of dispersants is important. Typical dispersants for use with titanium dioxide nanoparticles include aliphatic alcohols, saturated fatty acids and fatty acid amines.

The titanium dioxide nanoparticles of this invention can be incorporated into a sunscreen formulation. Typically the amount of titanium dioxide nanoparticles can be unto about 25 wt. %, typically from about 0.1 wt. % to up to 15 wt. %, even more preferably unto 6 wt. %, based on the weight of the formulation, the amount depending upon the desired sun protection factor (SPF) of the formulation. The sunscreen formulations are usually an emulsion and the oil phase of the emulsion typically contains the UV active ingredients such as the titanium dioxide particles of this invention. Sunscreen formulations typically contain in addition to water, emollients, humectants, thickeners, UV actives, chelating agents, emulsifiers, suspending agents (typically if using particulate UV actives), waterproofers, film forming agents and preservatives.

Specific examples of preservatives include parabens. Specific examples of emollients include octyl palmitate, cetearyl alcohol, and dimethicone. Specific examples of humectants include propylene glycol, glycerin, and butylene glycol. Specific examples of thickeners include xanthan gum, magnesium aluminum silicate, cellulose gum, and hydrogenated castor oil. Specific examples of chelating agents include disodium ethylene diaminetetraacetic acid (EDTA) and tetrasodium EDTA. Specific examples of UV actives include ethylhexyl methoxycinnamate, octocrylene, and titanium dioxide. Specific examples of emulsifiers include glyceryl stearate, polyethyleneglycol-100 stearate, and ceteareth-20. Specific examples of suspending agents include diethanolamine-oleth-3-phosphate and neopentyl glycol dioctanoate. Specific examples of waterproofers include C30-38 olefin/isopropyl maleate/MA copolymer. Specific examples of film forming agents include hydroxyethyl cellulose and sodium carbomer.

To facilitate use by the customer, producers of titanium dioxide nanoparticles may prepare and provide dispersions of the particles in a fluid medium which are easier to incorporate into formulations.

Water based wood coatings, especially colored transparent and clear coatings benefit from a UV stabilizer which protects the wood. Organic UV absorbers are typically hydroxybenzophenones and hydroxyphenyl benzotriazoles. A commercially available UV absorber is sold under the trade name Tinuvin™ by Ciba. These organic materials, however, have a short life and decompose on exterior exposure. Replacing some or all of the organic material with titanium dioxide nanoparticles would allow very long lasting UV protection. The photo passivated titanium dioxide of this invention prevents the titanium dioxide from oxidizing the polymer in the wood coating, and is sufficiently transparent so the desired wood color can be seen. Because most wood coatings are water based, the titanium dioxide needs to be dispersible in the water phase. Various organic surfactants known in the art can be used to disperse the titanium dioxide nanoparticles in water.

Many cars are now coated with a clear layer of polymer coating to protect the underlying color coat, and ultimately the metal body parts. This layer has organic UV protectors, and like wood coatings, a more permanent replacement for these materials is desired. The clear coat layers are normally solvent based, but can also be water based. Such coatings are well known in the art. The titanium dioxide nanoparticles of this invention can be modified for either solvent or water based systems with appropriate surfactants or organic surface treatments.

When treated for reduced photo activity, the titanium dioxide particles of this invention can be beneficial in products which degrade upon exposure to UV light energy such as thermoplastics and surface coatings.

Titanium dioxide nanoparticles can also be used to increase the mechanical strength of thermoplastic composites. Most of these applications also require a high degree of transparency and passivation so underlying color or patterns are visible and the plastic is not degraded by the photoactivity of the titanium dioxide nanoparticles. The titanium dioxide nanoparticles must be compatible with the plastic and easily compounded into it. This application typically employs organic surface modification of the titanium dioxide nanoparticles as described herein above. The foregoing thermoplastic composites are well known in the art.

Polymers which are suitable as thermoplastic materials for use in the present invention include, by way of example but not limited thereto, polymers of ethylenically unsaturated monomers including olefins such as polyethylene, polypropylene, polybutylene, and copolymers of ethylene with higher olefins such as alpha olefins containing 4 to 10 carbon atoms or vinyl acetate, etc.; vinyls such as polyvinyl chloride, polyvinyl esters such as polyvinyl acetate, polystyrene, acrylic homopolymers and copolymers; phenolics; alkyds; amino resins; epoxy resins, polyamides, polyurethanes; phenoxy resins, polysulfones; polycarbonates; polyether and chlorinated polyesters; polyethers; acetal resins; polyimides; and polyoxyethylenes. The polymers according to the present invention also include various rubbers and/or elastomers either natural or synthetic polymers based on copolymerization, grafting, or physical blending of various diene monomers with the above-mentioned polymers, all as generally well known in the art. Thus generally, the present invention is useful for any plastic or elastomeric compositions (which can also be pigmented with pigmentary TiO₂). For example, but not by way of limitation, the invention is felt to be particularly useful for polyolefins such as polyethylene and polypropylene, polyvinyl chloride, polyamides and polyester.

From the refractive index of compositions of matter of this invention it would be apparent to those skilled in the optics art that the compositions of this invention can be useful in optics. The TiO₂ product of this invention could be combined with polymethylmethacrylate polymer and made into an optical device. Other techniques for incorporating the compositions of this invention into optical devices would be apparent to those skilled in the art of making optical devices.

Additionally, compositions of matter of this invention can be useful in electronics. For example the TiO₂ product of this invention could be used in photovoltaic devices. As an example, a TiO₂ product can be combined with a binder and cast into a film on a conducting substrate by well-known techniques to form an anode which can be used in a solar cell. Other suitable techniques for incorporating products of this invention into photovoltaic devices would be apparent to those skilled in the electronics art. TiO₂ products of this invention can provide high powder conversion efficiency in solar cell applications.

In one embodiment, the invention herein can be construed as excluding any element or process step that does not materially affect the basic and novel characteristics of the composition or process. Additionally, the invention can be construed as excluding any element or process step not specified herein.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The examples which follow, description of illustrative and preferred embodiments of the present invention are not intended to limit the scope of the invention. Various modifications, alternative constructions and equivalents may be employed without departing from the true spirit and scope of the appended claims.

### TEST METHODS

The following test methods and procedures were used in the Examples below:

Nitrogen Porosimetry: Dinitrogen adsorption/desorption measurements were performed at 77.3 K on Micromeritics ASAP® model 2400/2405 porosimeters (Micromeritics Inc., One Micromeritics Drive, Norcross Ga. 30093-1877). Samples were degassed at 150° C. overnight prior to data collection. Surface area measurements utilized a five-point adsorption isotherm collected over 0.05 to 0.20 p/p₀ and analyzed via the BET method (S. Brunauer, P. H. Emmett and E. Teller, J. Amer. Chem. Soc., 60, 309(1938)). Pore volume distributions utilized a 27 point desorption isotherm and were analyzed via the BJH method (E. P. Barret, L. G. Joyner and P. P. Halenda, J. Amer. Chem. Soc., 73, 373(1951)).

X-ray Powder Diffraction: Room-temperature powder x-ray diffraction data were obtained with a Philips X'PERT automated powder diffractometer, Model 3040. Samples were run in batch mode with a Model PW 1775 or Model PW 3065 multi-position sample changer. The diffractometer was equipped with an automatic variable slit, a xenon proportional counter, and a graphite monochromator. The radiation was CuK(alpha) (45 kV, 40 mA). Data were collected from 2 to 60 degrees 2-theta; a continuous scan with an equivalent step size of 0.03 deg; and a count time of 0.5 seconds per step.

Thermogravimetric Analysis: About 5-20 mg samples were loaded into platinum TGA pans. Samples were heated in a TA Instruments 2950 TGA under 60 ml/min air purge and 40 ml/min N₂ in the balance area (total purge rate was 100 ml/min). Samples were heated from RT to 800° C. at 10° C./min. The temperature scale of the TGA was previously calibrated at the 10° C./min rate using thermomagnetic standards.

Ionic Conductivity: Ionic conductivity was measured with a VWR traceable conductivity/resistivity/salinity concentration meter.

### EXAMPLES

In the following Examples and Comparative Examples, titanium dioxide and titanium-oxide hydrate was formed and characterized, and utility was demonstrated by using the product as a nanoparticle precursor, in a photovoltaic material, and in an optical device. Surface area and porosity data are summarized in Table 1.

| | |
|---|---|
| TiCl₄ | Aldrich Chemical Co., Milwaukee, WI, 99.9% |
| ZrOCl₂.8H₂O | Alfa Aesar, Ward Hill, MA, 99.9% |
| HfOCl₂.8H₂O | Alfa Aesar, Ward Hill, MA, 99.98% |
| ethanol | Pharmco, Brookfield, CT, ACS/USP Grade 200 Proof |
| NH₄OH | EMD Chemicals, Gibbstown, NJ, 28.0-30.0% |
| NH₄Cl | EMD Chemicals, Gibbstown, NJ, 99.5% |
| n-propanol | EMD Chemicals, Gibbstown, NJ, 99.99% |
| isopropanol | EMD Chemicals, Gibbstown, NJ, 99.5% |
| n-butanol | EMD Chemicals, Gibbstown, NJ, 99.97% |
| iso-butanol | EMD Chemicals, Gibbstown, NJ, 99.0% |
| tert-butanol | EMD Chemicals, Gibbstown, NJ, 99.0% |
| DMAc | EMD Chemicals, Gibbstown, NJ, 99.9% (N, N′ |
| | dimethylacetamide) |
| acetone | EMD Chemicals, Gibbstown, NJ, 99.5% |
| | (reagent bottle) |
| TiO₂ | Degussa Inc., Parsipanny, NJ, P25 |
| TSPP | tetrasodiumpyrophosphate (CAS number 7722-88-5) |

All references herein to elements of the Periodic Table of the Elements are to the CAS version of the Periodic Table of the Elements.

### Comparative Example A

This example illustrates that reaction of TiCl₄ and NH₄OH in water alone does not produce a TiO₂ product, uncalcined or calcined, having the surface area and porosity properties of TiO₂ made by processes of this invention. The precipitate formed from the reaction of TiCl₄ and NH₄OH is washed extensively to remove any trapped NH₄Cl byproduct.

20.0 g (14 mL) of 50% wt TiCl₄ in H₂O were added to about 200 mL deionized water while stirring with a Teflon coated magnetic stirring bar in a 400 mL Pyrex beaker. With stirring, 14.5 mL concentrated NH₄OH (i.e., ˜30% wt =14.8 M) were added to the titanium solution. The pH of the slurry, measured with multi-color strip pH paper, was about 7. The resulting slurry was stirred for 60 minutes at ambient temperature.

The solid was washed extensively with deionized water until the clear, colorless supernatant wash water had a low ionic conductivity value, 12 μS/cm. The solid was collected by suction filtration and dried under an IR heat lamp. An X-ray powder diffraction pattern showed the material to be amorphous. Nitrogen porosimetry measurements of this uncalcined powder revealed a surface area of 398 m²/g, an average pore volume of 0.37 cc/g, and an average pore diameter of 37 Å.

The powder was transferred to an alumina crucible and heated uncovered from room temperature to 450° C. over the period of one hour, and held at 450° C. for an additional hour. The crucible and its contents were removed from the furnace and cooled naturally to room temperature.

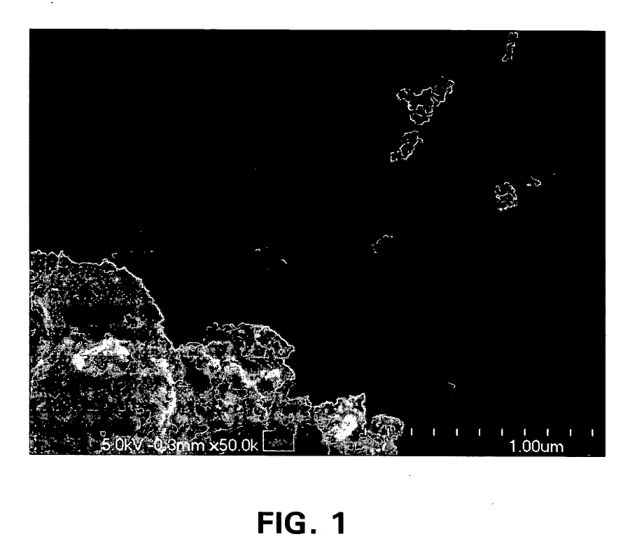

An X-ray powder diffraction pattern of the calcined material showed only the broad lines of anatase indicating an average crystal size of 16 nm. Nitrogen porosimetry revealed a surface area of 72 m²/g, an average pore volume of 0.17 cc/g, and an average pore diameter of 95 Å. FIG. 1 is a scanning electron microscope (SEM) image of the calcined powder, at a magnification of 50,000×, showing the product is compacted with low porosity.

### Comparative Example B

This example also illustrates that reaction of TiCl₄ and NH₄OH in water alone does not produce a TiO₂ product, uncalcined or calcined, having the surface area and porosity properties of a TiO₂ product of this invention. Here, the precipitate formed from the reaction of TiCl₄ and NH₄OH is collected and processed without the washing step used in Comparative Example A to remove NH₄Cl byproduct.

20.0 g (14 mL) of 50% wt TiCl₄ in H₂O were added to about 200 mL deionized water while stirring with a Teflon coated magnetic stirring bar in a 400 mL Pyrex beaker. With stirring, 28 mL 1:1 NH₄OH (i.e., 14-15% wt=7.5 M) were added to the titanium solution. The pH of the slurry, measured with multi-color strip pH paper, was about 5. The resulting slurry was stirred for 60 minutes at ambient temperature.

The unwashed solid was collected by suction filtration and dried under an IR heat lamp. An X-ray powder diffraction pattern showed the lines of NH₄Cl and a trace of anatase. Nitrogen porosimetry measurements of this mixture revealed a surface area of 215 m²/g, an average pore volume of 0.17 cc/g, and an average pore diameter of 31 Å.

The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed broad lines of anatase as the most intense and also showed one line of brookite with very low intensity. Nitrogen porosimetry revealed a surface area of 70 m²/g, an average pore volume of 0.25 cc/g, and an average pore diameter of 146 Å.

### Comparative Example C

This example illustrates that reaction of TiCl₄ and NH₄OH using acetone as the solvent does not result in a calcined TiO₂ having the surface area and porosity properties of a calcined TiO₂ product made by the process of this invention.

20.0 g (14 mL) of 50% wt TiCl₄ in H₂O were added to about 200 mL acetone while stirring with a Teflon coated magnetic stirring bar in a 400 mL Pyrex beaker. With stirring, 28 mL 1:1 NH₄OH (i.e., 14-15% wt=7.5 M) were added to the titanium solution. The pH of the slurry, measured with water moistened multi-color strip pH paper, was about 7. The resulting slurry was stirred for 60 minutes at ambient temperature.

The solid was collected by suction filtration and dried under an IR heat lamp to yield 14.5 g of white powder. An X-ray powder diffraction pattern showed only the lines of NH₄Cl.

The powder was transferred to an alumina crucible and heated uncovered from room temperature to 450° C. over the period of one hour, and held at 450° C. for an additional hour. The crucible and its contents were removed from the furnace and cooled naturally to room temperature. It was observed that the volume of powder after calcination was about half the volume of the starting precalcined powder.

An X-ray powder diffraction pattern of the calcined material showed broad lines of anatase as the most intense, and also showed some lines of rutile with very low intensity, as well as some amorphous material. Nitrogen porosimetry revealed a surface area of 75.8 m²/g, an average pore volume of 0.24 cc/g, and an average pore diameter of 129 Å.

### Comparative Example D

This example describes that reaction of TiCl₄ and NH₄OH in the three butanol isomers to form TiO₂.

20.0 g (14 mL) of 50% wt TiCl₄ in H₂O were added to about 200 mL n-butanol, tert-butyl alcohol, and isobutyl alcohol, respectively, while stirring with a Teflon coated magnetic stirring bar in 400 mL Pyrex beakers. With stirring, 29 mL 1:1 NH₄OH (i.e., 14-15% wt=7.5 M) were added to each of the three titanium solutions. The pH of the slurries was measured with water moistened multi-color strip pH paper and observed to be in the range of ˜6-7. The slurries were stirred for 60 minutes at ambient temperature.

The solids were each collected by suction filtration and dried under an IR heat lamp to give yields of 14.7 g, 13.3 g, and 13.1 g, respectively. X-ray powder diffraction patterns showed only the lines of NH₄Cl for the n-butanol and tert-butyl alcohol reactions, and a trace of anatase in addition to NH₄Cl for the isobutyl alcohol reaction.

The powders were transferred to alumina crucibles and heated, uncovered, from room temperature to 450° C. over the period of one hour, and held at 450° C. for an additional hour. The crucibles and their contents were removed from the furnace and cooled naturally to room temperature. X-ray powder diffraction patterns of the calcined materials showed the following:

| Butanol | Crystalline phases determined by |
|---|---|
| solvent | XPD |
| n-butanol | anatase, trace of brookite |
| tert-butyl alcohol | anatase |
| isobutyl alcohol | anatase, NH₄Cl, small amount of rutile |

Nitrogen porosimetry revealed the following surface areas, average pore volumes, and average pore diameters:

| | | surface area | ave. pore vol. | ave. pore diam. |
|---|---|---|---|---|
| | | (m²/g) | (cc/g) | (Å) |
| (I) | n-butanol | 82 | 0.4 | 193 |
| (II) | tert-butyl | 74 | 0.37 | 202 |
| | alcohol | | | |
| (III) | isobutyl | 109 | 0.28 | 105 |
| | alcohol | | | |

As shown in the table of this Comparative Example D, the TiO₂ product formed using each of the three different butanol isomers did not have the porosity properties of TiO₂ produced by the process of this invention.

### Example 1

This example illustrates that reaction of TiCl₄ and NH₄OH in aqueous saturated NH₄Cl can produce a calcined mesoporous nanocrystalline TiO₂ powder having a high surface area and high average porosity.

20.0 g (14 mL) of 50% wt TiCl₄ in H₂O were added to about 250 mL aqueous NH₄Cl solution, made by dissolving 73 g NH₄Cl in 200 g deionized H₂O, with stirring with a Teflon coated magnetic stirring bar in a 400 mL Pyrex beaker. With continued stirring, 30 mL 1:1 NH₄OH (i.e., 14-15% wt or 7.5 M) were added to the titanium-chloride/ammonium chloride solution. The pH of the slurry, measured with multi-color strip pH paper, was about 7. The resulting slurry was stirred for 60 minutes at ambient temperature.

The solid was collected by suction filtration and dried under an IR heat lamp to yield 14.9 g of white powder. The powder was then transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature.

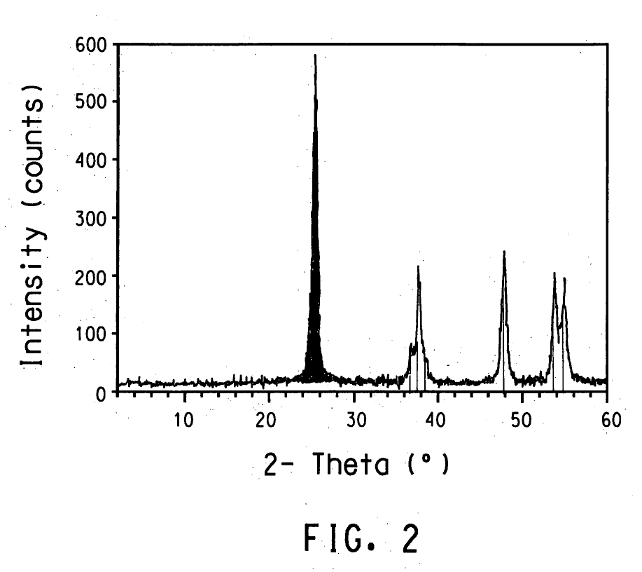

An X-ray powder diffraction pattern of the calcined material showed only broad lines of anatase and from the width of the strongest peak an average crystal size of 12 nm was estimated (FIG. 2). Nitrogen porosimetry revealed a surface area of 88 m²/g, an average pore volume of 0.72 cc/g, and an average pore diameter of 325 Å.

### Example 2

This example illustrates that reaction of TiCl₄ and NH₄OH in absolute ethanol can produce a calcined mesoporous nanocrystalline TiO₂ powder having a high surface area and high average porosity.

15 mL concentrated NH₄OH were added to about 200 mL absolute ethanol while stirring with a Teflon coated magnetic stirring bar in a 400 mL Pyrex beaker. With stirring, 20.0 g (14 mL) of 50% wt TiCl₄ in H₂O were added to the basic solution. The pH of the slurry, measured with water moistened multi-color strip pH paper, was about 8. The resulting slurry was stirred for 60 minutes at ambient temperature.

The solid was collected by suction filtration and dried under an IR heat lamp. The powder was transferred to an alumina boat and heated uncovered from room temperature to 450° C. over the period of one hour, and held at 450° C. for an additional hour. The furnace with the boat and its contents were cooled naturally to room temperature. An X-ray powder diffraction pattern of the calcined material showed only the broad lines of anatase. Nitrogen porosimetry revealed a surface area of 84 m²/g, an average pore volume of 0.78 cc/g, and an average pore diameter of 371 Å.

### Example 3

This example illustrates that adding NH₄OH to a solution of TiCl₄ in n-propanol can produce a calcined mesoporous nanocrystalline TiO₂ powder having a high surface area and high average porosity.

20.0 g (14 mL) of 50% wt TiCl₄ in H₂O were added to about 200 mL n-propanol while stirring with a Teflon coated magnetic stirring bar in a 400 mL Pyrex beaker. With stirring, 28 mL 1:1 NH₄OH (i.e., 14-15% wt or 7.5 M) were added to the titanium solution. The pH of the slurry, measured with water moistened multi-color strip pH paper, was about 6. The resulting slurry was stirred for 60 minutes at ambient temperature.

The solid was collected by suction filtration and dried under an IR heat lamp to yield 13.0 g of white powder. An X-ray powder diffraction pattern showed only the lines of NH₄Cl. The powder was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature. Surprisingly, the volume of powder after calcination was almost the same as that of the starting pre-calcined powder, even though the amount of NH₄Cl in the starting mixture was ˜65% by weight.

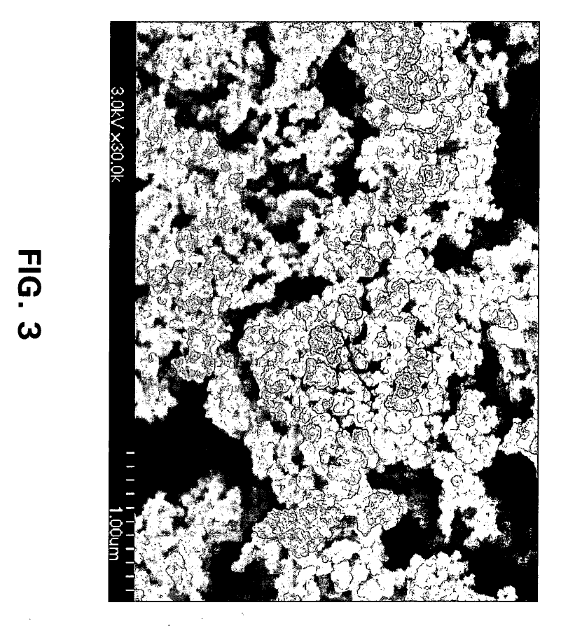

Nitrogen porosimetry revealed a surface area of 89 m²/g, an average pore volume of 0.65 cc/g, and an average pore diameter of 293 Å. A Scanning Electron Microscopy image at 30,000× magnification, FIG. 3, shows porous agglomerates of TiO₂ crystals.

### Example 4

This example illustrates that adding TiCl₄ to a solution of NH₄OH in n-propanol can produce a calcined mesoporous nanocrystalline TiO₂ powder having a high surface area and high average porosity.

37.5 mL concentrated NH₄OH were added to about 500 mL n-propanol while stirring with a Teflon coated magnetic stirring bar in a 1 L Pyrex beaker. With continued stirring, 35 mL of 50% wt TiCl₄ in H₂O were added to the NH₄OH-propanol solution. The resulting slurry with pH 7 was stirred for 60 minutes at ambient temperature.

The solid was collected by suction filtration and dried under an IR heat lamp. The voluminous powder was transferred to alumina boats and heated uncovered, under flowing air in a tube furnace, from room temperature to about 450° C. over the period of one hour, and held at about 450° C. for an additional hour to ensure removal of the volatile NH₄Cl. The furnace was allowed to cool naturally to room temperature, and the fired material was recovered.

An X-ray powder diffraction pattern of the calcined material showed the broad lines of anatase and a trace of rutile. Nitrogen porosimetry revealed a surface area of 86 m²/g, an average pore volume of 0.93 cc/g, and an average pore diameter of 435 Å. FIG. 4 is a Scanning Electron Microscopy image at 50,000× magnification showing very porous agglomerates of TiO₂ crystals.

### Example 5

This example, where NH₄OH is added to a solution of TiCl₄ in n-propanol in the presence of a surfactant, describes a calcined mesoporous nanocrystalline TiO₂ powder having a high surface area and high average porosity.

20.0 g (14 mL) of 50% wt TiCl₄ in H₂O were added to about 200 mL of 5% wt Pluronic P123 (BASF Corp) surfactant in n-propanol while stirring with a Teflon coated magnetic stirring bar in a 400 mL Pyrex beaker. With stirring, 29 mL 1:1 NH₄OH (i.e., 14-15% wt or 7.5 M) were added to the titanium solution. The resulting slurry was stirred for 60 minutes at ambient temperature.

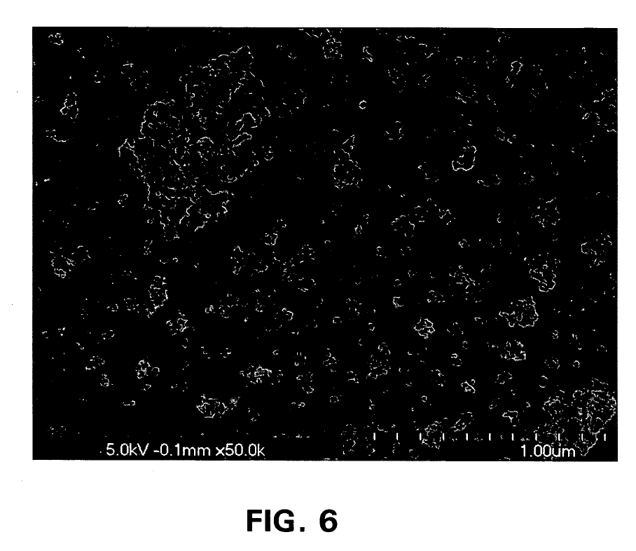

The solid was collected by suction filtration and dried under an IR heat lamp to yield 14.1 g of white powder. The powder was transferred to an alumina crucible and heated uncovered from room temperature to 450° C. over the period of one hour, and held at 450° C. for an additional hour to ensure removal of the volatile NH₄Cl template. The crucible and its contents were removed from the furnace and cooled naturally to room temperature. An X-ray powder diffraction pattern of the calcined material showed broad lines of anatase (14 nm average crystal size), and a very small amount of rutile. Nitrogen porosimetry revealed a surface area of 91 m²/g, an average pore volume of 0.63 cc/g, and an average pore diameter of 276 Å. FIGS. 5 and 6 are scanning electron microscopy images with magnifications of 25,000× and 50,000×, respectively, showing very porous agglomerates of TiO₂ particles.

### Example 6

This example illustrates that reaction of neat TiCl₄ and NH₄OH in n-propanol results in a calcined mesoporous nanocrystalline TiO₂ powder having a high surface area and high average porosity.

10 g of 99.995 TiCl₄ were added to about 200 mL n-propanol while stirring with a Teflon coated magnetic stirring bar in a 400 mL Pyrex beaker. With stirring, 16 mL concentrated NH₄OH were added to the titanium solution. The thick slurry was thinned with an additional small portion of n-propanol. The pH of the slurry, measured with water moistened multi-color strip pH paper, was about 7-8. The resulting slurry was stirred for 60 minutes at ambient temperature.

The solid was collected by suction filtration and dried under an IR heat lamp to yield 16.1 g of white powder. An X-ray powder diffraction pattern showed only the lines of NH₄Cl. A TGA of this mixture exhibited a total weight loss of 74% up to ˜300° C. indicating that most of the NH₄Cl had been precipitated along with the TiO₂.

The powder was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature. An X-ray powder diffraction pattern of the calcined material showed broad lines of anatase, a very small amount of brookite, and some amorphous material. Nitrogen porosimetry revealed a surface area of 89 m²/g, an average pore volume of 0.56 cc/g, and an average pore diameter of 251 Å.

### Example 7

This example illustrates that adding NH₄OH to a solution of TiCl₄ in isopropanol results in a calcined mesoporous nanocrystalline TiO₂ powder having a high surface area and high average porosity.

20.0 g (14 mL) of 50% wt TiCl₄ in H₂O were added to about 200 mL isopropanol while stirring with a Teflon coated magnetic stirring bar in a 400 mL Pyrex beaker. With stirring, 30 mL 1:1 NH₄OH (i.e., 14-15% wt or 7.5 M) were added to the titanium solution. The resulting slurry was stirred for 60 minutes at ambient temperature.

The solid was collected by suction filtration and dried under an IR heat lamp. An X-ray powder diffraction pattern showed only the lines of NH₄Cl.

The powder was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature.

An X-ray powder diffraction pattern of the calcined material showed only broad lines of anatase and some amorphous material. The average crystallite size of the anatase was estimated to be 11 nm from X-ray peak broadening analysis. Nitrogen porosimetry revealed a surface area of 78 m²/g, an average pore volume of 0.74 cc/g, and an average pore diameter of 378 Å.

### Example 8

This example illustrates that adding NH₄OH to a solution of TiCl₄ in N,N′ dimethylacetamide (DMAC) resulted in a calcined mesoporous nanocrystalline TiO₂ powder having a high surface area and high average porosity.

20.0 g (14 mL) of 50% wt TiCl₄ in H₂O were added to about 200 mL N,N′ dimethylacetamide (DMAC) while stirring with a Teflon coated magnetic stirring bar in a 400 mL Pyrex beaker. With stirring, 29 mL 1:1 NH₄OH were added to the titanium solution. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour to ensure removal of the volatile NH₄Cl porogen. The crucible and its contents were removed from the furnace and cooled naturally to room temperature. An X-ray powder diffraction pattern of the calcined material showed only broad lines of anatase with an average crystallite size of 13 nm. Nitrogen porosimetry revealed a surface area of 88 m²/g, an average pore volume of 0.68 cc/g, and an average pore diameter of 313 Å.

### Example 9

This example illustrates that addition of NH₄Cl to the aqueous slurry formed by reaction of NH₄OH with TiCl₄ results in a calcined mesoporous nanocrystalline TiO₂ powder having a high surface area and high average porosity.

20.0 g (14 mL) of 50% wt TiCl₄ in H₂O were added to about 200 mL deionized H₂O while stirring with a Teflon coated magnetic stirring bar in a 400 mL Pyrex beaker. With stirring, 29 mL 1:1 NH₄OH (i.e., 14-15% wt or 7.5 M) were added to the titanium solution. The pH of the slurry was about 8. After a few minutes, 89 g NH₄Cl were added to the slurry, and the mixture was stirred for 60 minutes at ambient temperature.

The solid was collected by suction filtration and dried under an IR heat lamp. An X-ray powder diffraction pattern showed only the lines of NH₄Cl. The powder was transferred to an alumina crucible and heated uncovered from room temperature to about 450° C. over the period of one hour, and held at about 450° C. for an additional hour to ensure removal of the volatile NH₄Cl. The crucible and its contents were removed from the furnace and cooled naturally to room temperature.

An X-ray powder diffraction pattern of the calcined material showed the broad lines of anatase and a very small amount of brookite. Nitrogen porosimetry revealed a surface area of 80 m²/g, an average pore volume of 0.52 cc/g, and an average pore diameter of 260 Å

### Example 10

This example illustrates that adding NH₄OH to a solution of TiCl₄ in n-propanol resulted in a washed and dried, uncalcined, mesoporous, TiO₂ powder having a very high surface area and high average porosity.

12.5 g TiCl₄ were added to about 200 mL n-propanol while stirring with a Teflon coated magnetic stirring bar in a 400 mL Pyrex beaker. With stirring, 19 mL concentrated NH₄OH were added to the titanium solution. The resulting slurry was stirred for 60 minutes at ambient temperature.

The solid was collected by suction filtration and dried under an IR heat lamp. The mixture was slurried in 1 L deionized water, stirred for 15 minutes, and collected by suction filtration. The latter step was repeated, but this time stirring of the slurry was extended to 90 minutes. After overnight drying at room temperature, a voluminous 7.7 g of powder was recovered. An X-ray powder diffraction pattern showed the washed TiO₂ to be amorphous. Nitrogen porosimetry measurements on this mixture revealed a surface area of 511 m²/g, an average pore volume of 0.86 cc/g, and an average pore diameter of 68 Å.

### Comparative Example E

This example shows that calcination of the washed and dried TiO₂ product of Example 10, which no longer contains sufficient NH₄Cl porogen, does not give a nanocrystalline TiO₂ powder having the high surface area and high porosity of TiO₂ made by processes of this invention.

The washed and dried powder in Example 10 was transferred to an alumina crucible and heated uncovered from room temperature to 450° C. over the period of one hour, and held at 450° C. for an additional hour to ensure removal of the volatile NH₄Cl. The crucible and its contents were removed from the furnace and cooled naturally to room temperature. X-ray powder diffraction of the calcined material showed only broad lines of anatase and some amorphous material. Nitrogen porosimetry revealed a surface area of 61 m²/g, an average pore volume of 0.34 cc/g, and an average pore diameter of 223 Å.

### Example 11

This example, where NH₄OH is added to a solution of TiCl₄ in n-propanol in the presence of a surfactant, describes a washed and dried, uncalcined mesoporous TiO₂ powder having a very high surface area and high average porosity.

Example 5 was repeated, but rather than drying and calcining, the filtered, undried product cake was slurried with 1 L deionized water, stirred for 75 minutes, and collected by suction filtration. This washing step was repeated two more times. The filtered white powder was dried under an IR heat lamp. An X-ray powder diffraction pattern showed the washed and dried product to be amorphous. Nitrogen porosimetry revealed a surface area of 526 m²/g, an average pore volume of 0.47 cc/g, and an average pore diameter of 35 Å.

### Example 12

This example demonstrates the utility of the nanocrystalline, mesoporous, loosely agglomerated, titanium dioxide product as a nanoparticle precursor. Micron size TiO₂ particles are deagglomerated by a factor of 100-500, e.g., particles having a d₅₀˜50 μm are reduced in size to have d₅₀˜0.100 μm (100 nm).

TiO₂ powders from Examples 1, 4, and 5 above were dispersed by shaking in water containing 0.1 wt % TSPP surfactant. The particle size distributions for these powders before and after 20 minutes of sonication are shown in Table 2.

| | d₅₀ (μm) | d₅₀ (μm) after 20 min. |
|---|---|---|
| TiO₂ powder | as prepared | sonication |
| Example 1 | 46.7 | 0.088 |
| Example 4 | 11.3 | 0.110 |
| Example 5 | 23.7 | 0.130 |

### Example 13

This example demonstrates the utility of the nanocrystalline, mesoporous, loosely agglomerated, titanium dioxide in a photovoltaic device. TiO₂ powder made as described in Example 3, was blended with a binder and cast into a film on an electrically-conducting fluorine-doped tin-oxide (FTO) coated glass substrate. This anode was assembled into a dye-sensitized solar cell and tested as described in section 2.5 of “Engineering of Efficient Panchromatic Sensitizers for Nanocrystalline TiO2-Based Solar Cells”, M. K. Nazeeruddin, et al., J. Am. Chem. Soc., volume 123, pp. 1613-1624, 2001. A control experiment using Degussa P25 TiO₂ was used for comparison. The cell containing TiO₂ of this invention exhibited a higher power conversion efficiency, relative to that of the control cell.

| | Relative power |
|---|---|
| TiO₂ film | conversion efficiency |
| Example 3 | 1.13 |
| Degussa | 1.00 |
| P25 | |

### Example 14

This example demonstrates the utility of the nanocrystalline, mesoporous, loosely agglomerated, titanium dioxide in an optical device. The index of refraction of a polymethylmethacrylate (PMMA) polymer film was modified by blending the PMMA polymer with TiO₂ powder from Example 4 to make composite films containing 5% wt TiO₂.

| | index of refraction |
|---|---|
| Film | at 1550 nm |
| PMMA (two sample films) | 1.479, 1.479 |
| PMMA + TiO₂ from Example 4 | 1.512, 1.514 |
| (two composite sample films) | |

### Comparative Example F

This example shows that reaction of ZrOCl₂.8H₂O with NH₄OH in water does not result in calcined ZrO₂ as obtained via aqueous saturated NH₄Cl solution.

11.0 g ZrOCl₂.8H₂O were dissolved in 100 mL deionized H₂O while stirring with a Teflon coated magnetic stirring bar in a 250 mL Pyrex beaker. With stirring, 10 mL concentrated NH₄OH were added to the zirconium solution. The pH of the slurry, measured with multi-color strip pH paper, was about 10. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed a mixture of the monoclinic and tetragonal forms of ZrO₂ with the crystallites ranging 11-16 nm in size. Nitrogen porosimetry revealed a surface area of 63.4 m²/g, an average pore volume of 0.13 cc/g, and an average pore diameter of 84 Å.

### Example 15

This example, using ZrOCl₂.8H₂O in aqueous saturated NH₄Cl solution, illustrates the synthesis of calcined ZrO₂ product in accordance with this invention.

11.0 g ZrOCl₂.8H₂O were dissolved in 100 mL aqueous NH₄Cl solution saturated at room temperature, while stirring with a Teflon coated magnetic stirring bar in a 250 mL Pyrex beaker. With stirring, 20 mL 1:1 NH₄OH:H₂O were added to the zirconium solution. The pH of the slurry, measured with multi-color strip pH paper, was about 10. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the tetragonal form of ZrO₂ with 7 nm crystals. Nitrogen porosimetry revealed a surface area of 84 m²/g, an average pore volume of 0.31 cc/g, and an average pore diameter of 146 Å.

### Example 16

This example, using ZrOCl₂.8H₂O illustrates the synthesis of calcined product via addition of NH₄Cl after forming the ZrO₂ precipitate.

11.0 g ZrOCl₂.8H₂O were dissolved in 100 mL deionized H2O at room temperature while stirring with a Teflon coated magnetic stirring bar in a 250 mL Pyrex beaker. With stirring, 10 mL concentrated NH₄OH were added to the zirconium solution. After a few minutes, 45 g NH₄Cl were added to the slurry, and the mixture was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the tetragonal form of ZrO₂ with 7 nm crystals. Nitrogen porosimetry revealed a surface area of 81.5 m²/g, an average pore volume of 0.38 cc/g, and an average pore diameter of 187 Å.

### Comparative Example G

Reaction of HfOCl₂.8H₂O with NH₄OH in water does not give HfO₂, calcined, as obtained via aqueous saturated NH₄Cl solution.

10.0 g HfOCl₂.8H₂O were dissolved in 200 mL deionized H₂O while stirring with a Teflon coated magnetic stirring bar in a 250 mL Pyrex beaker. With stirring, 3.5 mL concentrated NH₄OH were added to the hafnium solution. The pH of the slurry, measured with multi-color strip pH paper, was about 8-9. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed it to be amorphous. Nitrogen porosimetry revealed a surface area of 62.5 m²/g, an average pore volume of 0.05 cc/g, and an average pore diameter of 29 Å.

### Example 17

This example, using HfOCl₂.8H₂O in aqueous saturated NH₄Cl solution, illustrates the synthesis of calcined HfO₂ product.

10.0 g HfOCl₂.8H₂O were dissolved in 200 mL aqueous NH₄Cl solution saturated at room temperature, while stirring with a Teflon coated magnetic stirring bar in a 250 mL Pyrex beaker. With stirring, 3.5 mL concentrated NH₄OH were added to the hafnium solution. The pH of the slurry, measured with multi-color strip pH paper, was about 8. The resulting slurry was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the monoclinic form of HfO₂ with crystallites approximately 8-11 nm in size. Nitrogen porosimetry revealed a surface area of 49.9 m²/g, an average pore volume of 0.20 cc/g, and an average pore diameter of 161 Å.

### Example 18

This example, using HfOCl₂.8H₂O illustrates the synthesis of calcined product via addition of NH₄Cl after forming the HfO₂ precipitate.

10.0 g HfOCl₂.8H₂O were dissolved in 200 mL deionized H₂O at room temperature while stirring with a Teflon coated magnetic stirring bar in a 250 mL Pyrex beaker. With stirring, 3.5 mL concentrated NH₄OH were added to the zirconium solution. After a few minutes, 85 g NH₄Cl were added to the slurry, and the mixture was stirred for 60 minutes at ambient temperature.

The solid was collected by suction filtration and dried under an IR heat lamp. The powder was transferred to an alumina crucible and heated uncovered from room temperature to 450° C. over the period of one hour, and held at 450° C. for an additional hour. The crucible and its contents were removed from the furnace and cooled naturally to room temperature.

An X-ray powder diffraction pattern of the calcined material showed only the monoclinic form of HfO₂ with crystallites 8-10 nm in size. Nitrogen porosimetry revealed a surface area of 53.2 m²/g, an average pore volume of 0.17 cc/g, and an average pore diameter of 130 Å.

TABLE 1

| | | | Ave. | Ave. |
|---|---|---|---|---|
| | | Surface | Pore | Pore |
| | | Area, | Vol. | Size |
| Example | Material | m²/g | (cc/g) | (Å) |
| Comparative A | TiO₂ | 398 | 0.37 | 37 |
| uncalcined | | | | |
| Comparative A calcined | | 72 | 0.17 | 95 |
| Comparative B | | 215 | 0.17 | 31 |
| uncalcined | | | | |
| Comparative B calcined | | 70 | 0.25 | 146 |
| Comparative C | | 75.8 | 0.24 | 129 |
| Comparative D-I | | 82 | 0.4 | 193 |
| Comparative D-II | | 74 | 0.37 | 202 |
| Comparative D-III | | 109 | 0.28 | 105 |
| 1 | | 88 | 0.72 | 325 |
| 2 | | 84 | 0.78 | 371 |
| 3 | | 89 | 0.65 | 293 |
| 4 | | 86 | 0.93 | 435 |
| 5 | | 91 | 0.63 | 276 |
| 6 | | 89 | 0.56 | 251 |
| 7 | | 78 | 0.74 | 378 |
| 8 | | 88 | 0.68 | 313 |
| 9 | | 80 | 0.52 | 260 |
| 10 | | 511 | 0.86 | 68 |
| Comparative E | | 61 | 0.34 | 223 |
| 11 | | 526 | 0.47 | 35 |
| Comparative F | ZrO₂ | 63.4 | 0.13 | 84 |
| 15 | | 84 | 0.31 | 146 |
| 16 | | 81.5 | 0.38 | 187 |
| Comparative G | HfO₂ | 62.5 | 0.05 | 29 |
| 17 | | 49.9 | 0.20 | 161 |
| 18 | | 53.2 | 0.17 | 130 |

What is claimed is:

1. A process for making a mesoporous oxide of titanium, zirconium or hafnium product, comprising:
precipitating an ionic porogen and a hydrolyzed compound comprising titanium, zirconium or hafnium; and
removing the ionic porogen from the precipitate to recover a mesoporous oxide of titanium, zirconium or hafnium, the ionic porogen being in sufficient amount to produce (i) a mesoporous titanium oxide product having an average pore volume of at least about 0.5 cc/g and an average pore diameter of at least about 200 Å, (ii) a mesoporous zirconium oxide product having an average pore volume of at least about 0.25 cc/g and an average pore diameter of at least about 100 Å or (iii) a mesoporous hafnium oxide product having an average pore volume of at least about 0.1 cc/g and an average pore diameter of at least about 100 Å.

2. The process of claim 1 wherein the ionic porogen is a halide salt.

3. The process of claim 2 wherein the halide salt is ammonium halide, tetramethyl ammonium halide or tetraethyl ammonium halide or combinations thereof.

4. The process of claim 1 wherein the ionic porogen is removed by calcining.

5. The process of claim 1 wherein the mesoporous oxide is crystalline.

6. The process of claim 1 wherein the oxide of titanium, zirconium or hafnium further comprises a dopant.

7. The process of claim 6 wherein the dopant is a transition metal, a Group IIA, IIIA, IVA, or VA metal.

8. The process of claim 7 wherein the dopant is Ge, P, As, Sb, Bi, Ni, Cu, Al, Zr, Hf, Si, Nb, Ta, Fe, Sn, Co, Zn, Mo, W, V, Cr, Mn, Mg, Ca, Sr, Ba, Ga, or In.

9. The process of claim 1 wherein the hydrolyzed compound containing titanium, zirconium or hafnium compound is derived from titanium tetrachloride, titanium oxychloride, zirconium oxychloride octahydrate, or hafnium oxychloride octahydrate.

10. A process for producing a mesoporous oxide of titanium, zirconium or hafnium product, the process comprising:
precipitating an ionic porogen and a hydrous oxide of titanium, zirconium or hafnium from a reaction mixture comprising a compound comprising titanium, zirconium or hafnium, a base and a solvent, wherein the compound comprising titanium, zirconium or hafnium or the solvent, or both, are a source of the anion for the ionic porogen and the base is the source of the cation for the ionic porogen; and
removing the ionic porogen from the precipitate to recover (i) a mesoporous titanium oxide product having an average pore volume of at least about 0.5 cc/g and an average pore diameter of at least about 200 Å, (ii) a mesoporous zirconium oxide product having an average pore volume of at least about 0.25 cc/g and an average pore diameter of at least about 100 Å or (iii) a mesoporous hafnium oxide product having an average pore volume of at least about 0.1 cc/g and an average pore diameter of at least about 100 Å.

11. The process of claim 10 wherein the ionic porogen is a halide salt.

12. The process of claim 11 wherein the halide salt is ammonium halide, tetramethyl ammonium halide or tetraethyl ammonium halide or combinations thereof.

13. The process of claim 10 wherein the ionic porogen is removed by calcining.

14. The process of claim 10 wherein the mesoporous oxide is crystalline.

15. The process of claim 10 wherein the oxide of titanium, zirconium or hafnium further comprises a dopant.

16. The process of claim 15 wherein the dopant is a transition metal, a Group IIA, IIIA, IVA, or VA metal.

17. The process of claim 15 wherein the dopant is Ge, P, As, Sb, Bi, Ni, Cu, Al, Zr, Hf, Si, Nb, Ta, Fe, Sn, Co, Zn, Mo, W, V, Cr, Mn, Mg, Ca, Sr, Ba, Ga, or In.

18. The process of claim 10 wherein the titanium, zirconium or hafnium compound is titanium tetrachloride, titanium oxychloride, zirconium oxychloride octahydrate, or hafnium oxychloride octahydrate.

19. The process of claim 10 wherein the base is ammonium hydroxide, ammonium carbonate, ammonium bicarbonate, tetramethyl ammonium hydroxide or tetraethyl ammonium hydroxide or combinations thereof.

20. The process of claim 10 wherein the solvent is ethanol, n-propanol, i-propanol, dimethyl acetamide, alcoholic ammonium halide and aqueous ammonium halide or combinations thereof.

21. The process of claim 20 wherein the halide is chloride, bromide or iodide or combinations thereof.

22. The process of claim 10 wherein the reaction mixture is formed by the steps, in order, of combining the base and the solvent to form a solution or a mixture and adding the compound comprising titanium, zirconium or hafnium to the solution or mixture.

23. The process of claim 10 wherein the step of forming the reaction mixture further comprises, in order, combining the compound comprising titanium, zirconium or hafnium and the solvent to form a solution or a mixture and adding the base to the solution or mixture.

24. The process of claim 10 wherein more than about 50 weight percent of the halide salt precipitates from the reaction mixture, the weight percent based on the total amount of the halide salt that can form from the reaction mixture.

25. The process of claim 10 wherein more than about 70 weight percent of the halide salt precipitates from the reaction mixture, the weight percent based on the total amount of the halide salt that can form from the reaction mixture.

26. The process of claim 11 wherein more than about 90 weight percent of the halide salt precipitates from the reaction mixture, the weight percent based on the total amount of the halide salt that can form from the reaction mixture.

27. A process for producing a mesoporous oxide of titanium, zirconium or hafnium product, the process comprising:
forming a mixture of a solid, hydrolyzed compound comprising titanium, zirconium or hafnium and a liquid medium;
adding a sufficient quantity of a halide salt to the mixture to saturate the liquid medium of the mixture;
recovering the solid from the saturated liquid medium, the solid comprising a hydrolyzed compound comprising titanium, zirconium or hafnium having pores containing the saturated liquid medium; and
removing the saturated liquid medium from the solid to recover (i) a mesoporous titanium oxide product having an average pore volume of at least about 0.5 cc/g and an average pore diameter of at least about 200 Å, (ii) a mesoporous zirconium oxide product having an average pore volume of at least about 0.25 cc/g and an average pore diameter of at least about 100 Å or (iii) a mesoporous hafnium oxide product having an average pore volume of at least about 0.1 cc/g and an average pore diameter of at least about 100 Å.

28. The process of claim 27 wherein the liquid medium is the liquid portion of the mixture which comprises a solvent.

29. The process of claim 28 wherein the solvent comprises a dissolved salt.

30. The process of claim 27 wherein the solvent is ethanol, n-propanol, i-propanol, dimethyl acetamide, alcoholic ammonium halide and aqueous ammonium halide or combinations thereof.

31. The process of claim 30 wherein the halide is chloride, bromide or iodide or combinations thereof.

32. The process of claim 27 wherein the liquid medium is an aqueous solution of titanium chloride or titanium oxychloride.

33. The process of claim 27 wherein the halide salt is ammonium halide, tetramethyl ammonium halide or tetraethyl ammonium halide or combinations thereof.

34. The process of claim 27 wherein the step of removing the saturated liquid medium comprises drying and calcining.

35. The process of claim 27 wherein the mesoporous oxide is crystalline.

36. The process of claim 27 wherein the oxide of titanium, zirconium or hafnium further comprises a dopant.

37. The process of claim 36 wherein the dopant is a transition metal, a Group IIA, IIIA, IVA, or VA metal.

38. The process of claim 36 wherein the dopant is Ge, P, As, Sb, Bi, Ni, Cu, Al, Zr, Hf, Si, Nb, Ta, Fe, Sn, Co, Zn, Mo, W, V, Cr, Mn, Mg, Ca, Sr, Ba, Ga, or In.

39. The process of claim 27 wherein the hydrolyzed compound comprising titanium, zirconium or hafnium is derived from titanium tetrachloride, titanium oxychloride, zirconium oxychloride octahydrate, or hafnium oxychloride octahydrate.

40. The process of claims 1, 10 or 27 wherein the mesoporous oxide of titanium is TiO₂ having a surface area at least about 70 m²/g, an average pore volume measured by nitrogen porosimetry of at least about 0.5 cc/g, and an average pore diameter of least about 200 Å.

41. The process of claims 1, 10 or 27 wherein the mesoporous oxide of zirconium comprises ZrO₂ having a surface area at least about 70 m²/g, an average pore volume of at least about 0.25 cc/g, and an average pore diameter of at least about 100 Å.

42. The process of claims 1, 10 or 27 wherein the mesoporous oxide of hafnium comprises HfO₂ having a surface area at least about 40 m²/g, an average pore volume of at least about 0.1 cc/g , and an average pore diameter of at least about 100 Å.

43. The process of claim 27 wherein the mixture further comprises a base.

44. The process of claim 43 wherein the base is selected from the group consisting of NH₄OH, NH₄HC0₃, (NH₄)₂CO₃, (CH₃)₄NOH or (CH₃CH₂)₄NOH.

45. A composition of matter comprising mesoporous titanium dioxide product having a microstructure characterized by a surface area of at least about 70 m²/g, an average pore volume of least about 0.5 cc/g, and an average pore diameter of least about 200 Å.

46. A composition of matter comprising ZrO₂ having a microstructure characterized by a surface area at least about 70 m²/g, an average pore volume of at least about 0.25 cc/g, and an average pore diameter of at least about 100 Å.

47. A composition of matter comprising HfO₂ having a microstructure characterized by a surface area at least about 40 m²/g, an average pore volume of at least about 0.1 cc/g, and an average pore diameter of at least about 100 Å.

48. A process for making a mesoporous amorphous oxide of titanium product, comprising:
precipitating an ionic porogen and a hydrolyzed compound comprising titanium; and
removing the ionic porogen from the precipitate to recover a mesoporous oxide of titanium, the ionic porogen being in sufficient amount to produce a mesoporous titanium oxide having a surface area of at least about 400 m²/g and an average pore volume of at least about 0.4 cc/g.

49. The process of claim 48 wherein the ionic porogen is a halide salt.

50. The process of claim 49 wherein the halide salt is ammonium halide, tetramethyl ammonium halide or tetraethyl ammonium halide or combinations thereof.

51. The process of claim 48 wherein the ionic porogen is removed by washing.

52. The process of claim 48 wherein the oxide of titanium further comprises a dopant.

53. The process of claim 52 wherein the dopant is a transition metal, a Group IIA, IIIA, IVA, or VA metal.

54. The process of claim 52 wherein the dopant is Ge, P, As, Sb, Bi, Ni, Cu, Al, Zr, Hf, Si, Nb, Ta, Fe, Sn, Co, Zn, Mo, W, V, Cr, Mn, Mg, Ca, Sr, Ba, Ga, or In.

55. The process of claim 48 wherein the hydrolyzed compound containing titanium is derived from titanium tetrachloride.

56. A mesoporous amorphous oxide of titanium product having a microstructure characterized by a surface area of at least about 400 m²/g and an average pore volume of at least about 0.4 cc/g.

57. The use of the metal oxide product of claims 45, 46, 47 and 56 as a catalyst or catalyst support.

58. The use of the metal oxide product of claims 45, 46, 47 and 56 as a nanoparticle precursor.

59. The use of the metal oxide of claims 45, 46, 47 and 56 in an optical device or an electronic device.

60. The use of the metal oxide of claims 45, 46, 47 and 56 in a photovoltaic cell.

61. The titanium dioxide of claim 45 which is treated with silica, alumina or both.

62. The titanium dioxide of claim 61 which is treated with an organic coating agent.

63. The titanium dioxide of claim 62 in which the organic coating agent is a silane or a siloxane.

64. The titanium dioxide of claim 56 which is treated with silica, alumina or both.

65. The titanium dioxide of claim 61 which is treated with an organic coating agent.

66. The titanium dioxide of claim 62 in which the organic coating agent is a silane or a polysiloxane.

67. The use of the titanium dioxide of claims 61, 62, 63, 64, 65 or 66 in a thermoplastic composition.

68. The use of the titanium dioxide of claims 61, 62, 63, 64, 65 or 66 in a protective coating composition.

69. A crystalline tetragonal mesoporous oxide of zirconium made by the process of claims 1, 10 and 27.

70. A crystalline monoclinic mesoporous oxide of hafnium made by the process of claims 1, 10 and 27.
